(19) United States
(12) Patent Application Publication
(10) Pub. No.: US 2013/0041484 A1
(43) Pub. Date: Feb. 14, 2013

(54) METHOD AND SYSTEM FOR ACQUIRING AND ANALYZING CONTROL LOOP FEEDBACK

(71) Applicant: Gary Pratt, Hartland, WI (US)

(72) Inventor: Gary Pratt, Hartland, WI (US)

(21) Appl. No.: 13/206,756

(22) Filed: Aug. 10, 2011

(51) Int. Cl. G05B 13/02

(52) U.S. Cl. 700/42

(57) ABSTRACT

A programmable logic controller is provided having an interface having at least one input/output terminal configured for connection to a plurality of nodes within a control loop, a proportional-integral-derivative controller coupled to the input module, an analyzer block coupled to the proportional-integral-derivative controller and the output, the analyzer block configured to acquire data for the control loop and analyze the data directly on the programmable logic controller. A method and system for acquiring and analyzing control loop data is also provided.

### BACKGROUND OF THE INVENTION

1. Field of the Invention

The field of the invention relates generally to automation of electromechanical processes, and more particularly, to certain new and useful advances in analyzing control loop feedback, of which the following is a specification, reference being had to the drawings accompanying and forming a part of the same.

2. Description of Related Art

Programmable logic controllers (“PLCs”) are widely used for automation and control. These include, but are not limited to, industrial automation, factory automation, building automation and the like. PLCs are typically programmed by users with a control program to implement their desired functionality. For example, a PLC may monitor input conditions such as motor speed, temperature, pressure, volumetric flow and the like. The control program is generally written in a programming language, such as function block diagram (“FBD”) or ladder logic. The control program is stored in memory within the PLC to instruct the PLC on what actions to take upon encountering certain input signals or conditions.

PLCs generally do not connect directly with the devices that they control. Instead, an interface module, or input/out module (“I/O module”) is used to provide the necessary connections and adapt the signals into a usable form for both the device and the PLC. I/O modules are typically mounted into respective slots located on a backplane board in a PLC. The slots are coupled together by a main bus that couples any I/O modules to a central processing unit (“CPU”).

Typically, the devices are arranged subject to open-loop or closed-loop control functions. Monitoring and optimizing these control loops leads to device latency and operations cost-savings, and thus, has been a major focus in the industry. The control loop(s) are monitored and optimized using many different standards, with a display to the user in the form of a Human-Machine Interface (HMI) and/or Graphical User Interface (GUIs). More complex systems use programming and monitoring software installed on a computer, with the PLC connected via a communication interface.

Data that is harvested from the control loops is generally monitored and analyzed by a user who must connect specialized test instruments to the I/O modules. The specialized equipment is configured to collect data and transfer it to a CPU at which time the data is analyzed, again, using specialized software.

For example, U.S. Pat. No. 7,024,336 describes a monitoring system in which as a tool (e.g., a stand-alone system, a networked system of computers, laptop computer, personal digital assistant, etc.) is coupled to a control system, that includes one or more testing functions (e.g., automated testing functions) in the form of one or more testing functions, such as a setpoint change, and is used in order to assess the response of a feedback control loop within control system. The testing tool is used to evaluate the performance of a control system.

Another example of control loop testing is provided in U.S. Pat. No. 7,538,512B2 which describes the use of an external diagnostics module to assess the health of the control loop. In this example, a diagnostics module is coupled to a decision-making module or processor for transmitting the health assessment signal to the control module or to an external indicator unit. The processor assess the health signal according to a particular model or suite of models, to determine necessary system changes (e.g., in terms of the control provided by control module) to optimize operation.

There are many drawbacks with the above-described ad hoc approaches. For example, the use of external hardware and software is costly and makes for an inefficient use of floor space. Also, external testing systems may be prone to error, because it introduces numerous new variables. Lastly, this approach suffers from the inability to monitor and test open loops without actually manually opening the loop. This is particularly detrimental where high loop gains do not allow for the loop to be manually opened, or where quiescent points (“Q-point or “Setpoint”) cannot be adequately controlled to provide sufficiently stable set-points for monitoring and testing non-linear systems.

Accordingly, to date, no suitable system or method for monitoring, acquiring and analyzing control loop data exists.

### BRIEF SUMMARY OF THE INVENTION

The present disclosure describes embodiments for acquiring, monitoring, and analyzing control loop data. Embodiments of the invention provide a system and method to acquire, analyze, and monitor control loop feedback data while also proactively optimizing the control loop directly on a PLC, thus eliminating the need for costly and complex external hardware and software.

Embodiments of the invention describe a programmable logic controller comprising an interface having at least one input/output terminal configured for connection to a plurality of nodes within a control loop, a central processing unit in communication with the digital input/output interface and having a processor configured to execute programmable instructions, which when executed by the processor cause the processor to, acquire data for the control loop, and algorithmically analyze the control loop data directly on the programmable logic controller.

Embodiments of the invention also describe a method for acquiring and analyzing control loop data, the control loop having a plurality of nodes, the method executable by a processor, comprising outputting a stimulus at a predetermined frequency to at least one node, receiving data from the nodes, and algorithmically analyze the node data directly on the programmable logic controller.

Embodiments of the invention thus differ from and improve over prior designs which rely on external hardware and software because it allows a user to perform control loop analysis directly on the PLC.

Benefits over and difference from prior approaches is that embodiments of the invention monitor the health of the control loop while automatically optimizing loop compensation parameters. The analyzer block as described significantly reduces the cost of alternate methods of performing loop analysis using expensive specialized test instruments. Also, it saves users significant time connecting external instruments and reconfiguring the PLC I/O to make internal nodes available to the external instrument. Furthermore, the analyzer block is significantly more convenient and much less complicated and error-prone when compared to techniques where data is gathered in real-time, transferred to an external computer and then post-processed using custom software or mathematical tools. Lastly, it also makes loop analysis possible on PLCs running high scan rates where it is not feasible to capture sufficient data for post analysis.

### BRIEF DESCRIPTION OF THE DRAWINGS

Other features and advantages of the disclosure will become apparent by reference to the accompanying drawings, in which:

FIG. 1 is a schematic diagram of an exemplary PLC in communication with a node, in accordance with a further embodiment of the present invention;

FIG. 2 is a schematic block diagram illustrating PLC in communication with an industrial plant, in accordance with a further embodiment of the present invention;

FIG. 3 is functional block diagram for acquiring and analyzing control loop feedback in an open loop system in in accordance with a further embodiment of the present invention;

FIG. 4 is functional block diagram for acquiring and analyzing control loop feedback in an closed loop system in in accordance with a further embodiment of the present invention;

FIG. 5 is a functional flow chart describing a step-wise method for acquiring and analyzing control loop feedback in an open loop system in in accordance with a further embodiment of the present invention;

FIG. 6 is functional block diagram for acquiring and analyzing control loop feedback from any point in a control loop system in in accordance with a further embodiment of the present invention; and

FIG. 7 is functional block diagram for acquiring and analyzing control loop feedback of FIG. 3 with the addition of a notification block.

Like reference characters designate identical or corresponding components and units throughout the several views, which are not to scale unless otherwise indicated.

### DETAILED DESCRIPTION

Embodiments of the present invention acquire, analyze and monitor control loop data. In particular, a programmable logic controller (“PLC”) is provided herein which allows a user to perform both open and closed loop analysis of control loops directly on the PLC. As such, in an embodiment, the PLC comprises an input/output interface having at least one input terminal and at least one output terminals configured for connection to a plurality of nodes within a control loop. As used herein, the term “node(s)” may refer to sensors or actuators (e.g., electric motors, pneumatic or hydraulic cylinders, magnetic relays, solenoids, etc.) connected into the control loop. The present invention is applicable in an analog control loop, and also a digital control loop. As such, the analog data is acquired through an analog interface via an analog to digital converter, or directly through a digital interface such as RS422, FieldBus, ProfiNet, etc. The analog values can be converted to 32 bit floating point variables, at which point the control loop and analysis can be performed using the 32 bit floating variables. In this embodiment, no discrete I/O (off or on) is necessary.

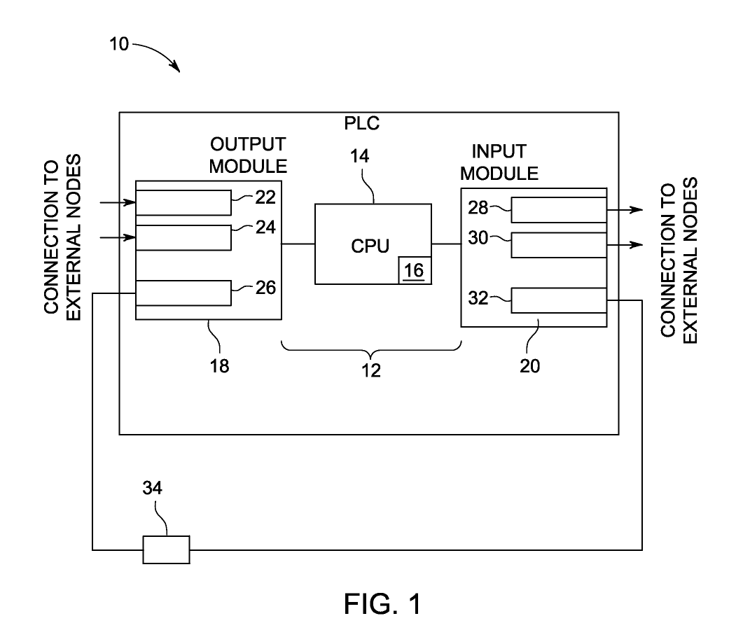

The PLC further comprises a central processing unit in communication on with the analog input/output interface. The central processing unit has a processor configured to execute programmable instructions, which when executed by the processor causes the processor to acquire data for the control loop, and algorithmically analyze the control loop data directly on the programmable logic controller, each of which will be discussed in greater detail below with reference to FIGS. 1-8.

This approach is different from prior approaches in that (1) acquiring and analyzing systems and control loop data is done on the PLC rather than by external hardware and software, and (2) in prior approaches users were obliged to manually open an open loop to retrieve data from internal nodes.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to industrial plant, a skilled artisan will recognize that embodiments of the invention can be implemented at theme parks and the like.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features. Further, as used herein, the term “setpoint” may be used synonymously with Quiescent point, Q-point, Operating Point, and DC Operating Point.

With reference now to FIG. 1, a block diagram of an exemplary PLC 10 having an analog I/O interface 12, and a central processing unit (“CPU”) 14, which has an embedded processor 16 is shown. The analog I/O interface 12 has an output module 18 and an input module 20. The I/O modules 18, 20 provide an isolation barrier between the nodes (i.e., field devices) 34 and the logic circuits connected to CPU 14. While, as shown in FIG. 1, input module 20 and output module 18 are two separate components, the I/O modules may be combined into a single component 12 that may be configured to operate as either an input module or an output module or a combination thereof. Further, the input/output arrangements may be coupled to the PLC 10 through a backplane, or the PLC may have external I/O modules attached to a computer network that connects into the PLC 10. In another embodiment, analog values conveyed over a digital media such as RS422 or Profinet.

The analog I/O modules 18 and 20 may comprise a plurality of I/Os 22-32, which are configured to connect to a plurality of nodes 34. As shown, six I/Os are embedded into the I/O module 12, but it should be appreciated that any number of I/Os may be employed. For exemplary purposes, node 34 is an actuator and is connected in a loop through output I/O 26 and I/O 32. Each switch is configured to provide an interface between the processor 16 and the node 34. For example, the I/Os 28-32 convert the external signal into a form usable by the logic circuits connected to CPU 14, while the I/Os 22-26, on the output module 18 and are arranged to receive signals from the CPU 14 and convert the signal into a form usable by the node 34.

In this exemplary embodiment, the PLC 10 has analog inputs and analog outputs, which may be, for example, 4-20 mA, 0-5V, Serial (i.e., RS422), ModBus, Ethernet, and the like. However, it should be noted that I/Os shown in FIG. 1 are not necessary for analog control loops, but are preferable for loops where external connections are desired. In the open loop configuration, the PLC may be connected to a DCS system, SCADA or HMI by a RS232 or RS434 communication cable.

The CPU 14 is configured to receive signals from the input module 20, which in turn, receives signals from the node 34 which indicates predetermined states or conditions of the node. The CPU 14 may be a general purpose microprocessor, or, in optional embodiments, may be an application-specific integrated circuit (“ASIC”) that includes a microprocessor 16, random-access memory (“RAM”) and read-only memory (“ROM”). The ROM contains the operating system for the PLC 10 and may either be EPROM or Flash EPROM depending on the type of PLC. The RAM is used for operating system data storage as well as storing control programs that the operator has compiled into executable code. The CPU 16 may further have additional components in the digital logic circuit such as Ethernet, universal asynchronous receiver transmitters, conditioning circuits, high speed counters, watchdog circuitry and bus interfaces for example, which facilitate execution of a control system.

The processor 16 is configured to receive or upload instructions to facilitate open loop and/or closed loop control of the node(s) 34. In this exemplary embodiment, a PLC Function Block (“FBD”) is uploaded to the processor and is configured to perform data acquisition, analysis and monitoring. However, it should be noted that other programming schemes/languages may be applicable that emphasize order of operations such as but not limited to Ladder Logic, Structured text, IL (Instruction lis) and SFC (Sequential function chart).

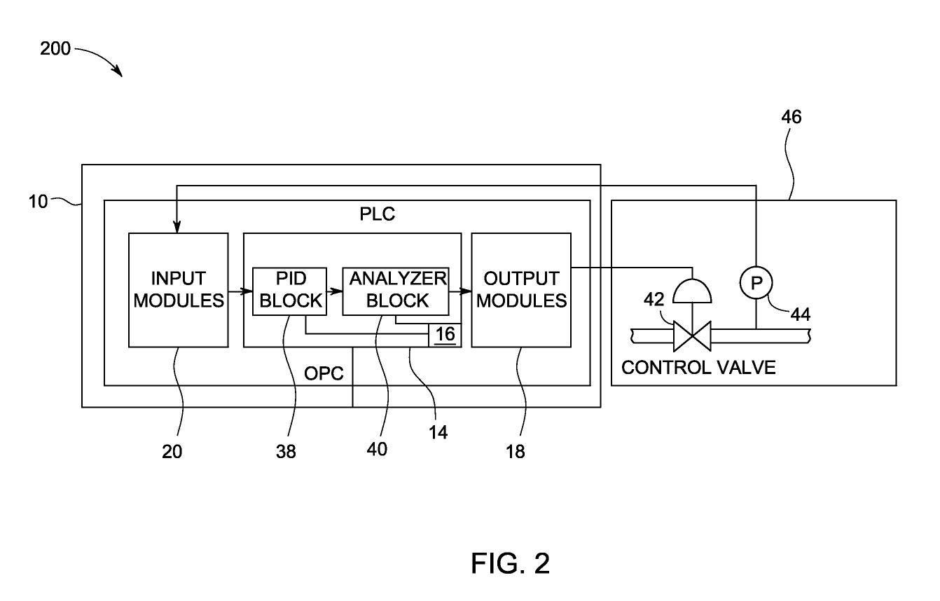

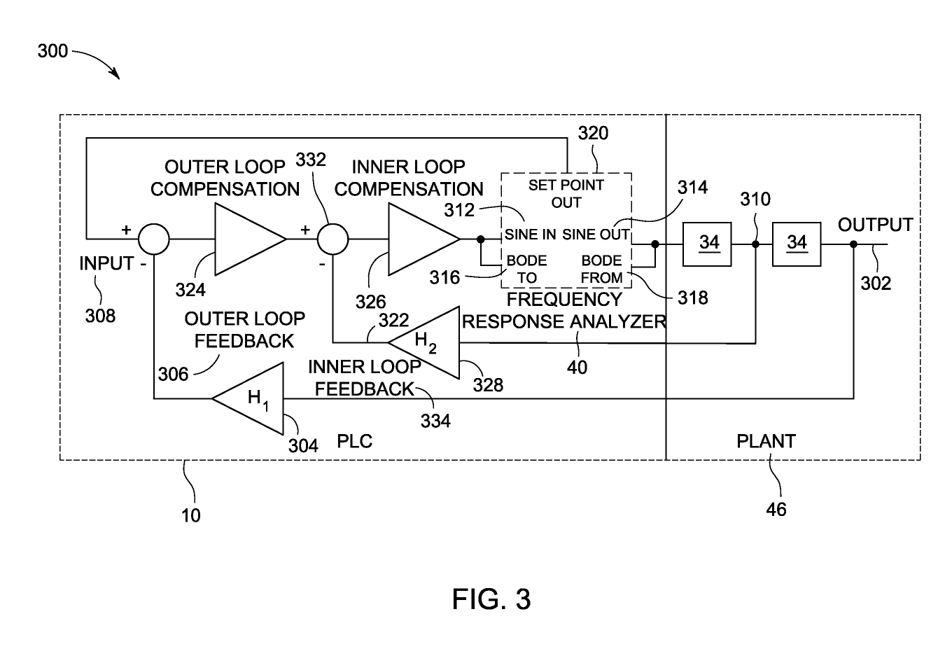

Referring now to FIG. 2, a more detailed embodiment of the PLC 10 shown in FIG. 1 connected to a control valve 42 is shown. In this embodiment, the CPU 14 comprises both a proportional-integral-derivative block 38 (PID block), and a function block 40 (also referred to herein as “analyzer block 40”), each of which are either in communication with or uploaded to the processor 16. The PID block is a control loop feedback controller configured to minimize error in a system by adjusting process variables, as is known in the art, based upon the calculation of error values between setpoint values and the measured process variables. The analyzer block 40, which will be discussed in greater detail with reference to FIGS. 3-7, may be inserted in to the control path, shown generally at 200.

For example, the control path 200 has a control valve 42 and a pressure sensor 44 connected thereto, which is further connected to the input module 20 of the PLC 10. The input module 20 is configured to provide an interface between the PID block 38 and the pressure sensor. The data gathered from the pressure sensor 44 is processed at PID block and sent to analyzer block 40, at which point the output module 18 is configured to signal the control valve 42 change its position based upon the error values calculated. However, unlike known systems, the insertion of analyzer block 40 provides the ability to analyze control loops and perform frequency response analysis directly on the PLC 10, while allowing users to make open loop measurements on a control loop without having to physically open the loop, which is particularly advantageous for open loops with high-gains or non-linear loops where it is not possible to maintain stable or desired quiescent points without some level of closed-loop feedback.

Referring now to FIG. 3, a function block diagram for an open loop measurement configuration is shown generally at 300. In operation, the instructions are uploaded or connected to processor 16, and are configured to provide predetermined functionality to the control loop. The analyzer block 40 is configured to take open loop measurements of a closed loop system, for example, when high loop gains do not readily allow the loop to be physically opened, or where the setpoint cannot be adequately controlled to provide stable setpoints for measuring a non-linear system.

The function block diagram 300 illustrates the functional relationship between the PLC 10 and an exemplary industrial plant 46, which has nodes 34, representing for example, control valves, gauges, pumps and the like. The analyzer block 40, which is inserted into the dual-loop control path, is configured to provide both a stimulus signal, such as a sinusoidal waves at predetermined various frequencies (SineIn 312 and SineOut 314), and measurement function (BodeTo 316 and BodeFrom 318), as well as the DC voltage at setpoint out 320 to bias the system nonlinear analysis. The stimulus signal, in this exemplary embodiment, is an AC signal having a zero DC value, and thus, acts as a short circuit, and perturbs the loop so that the response can be measured at the BodeTo 316 or BodeFrom 318 ports.

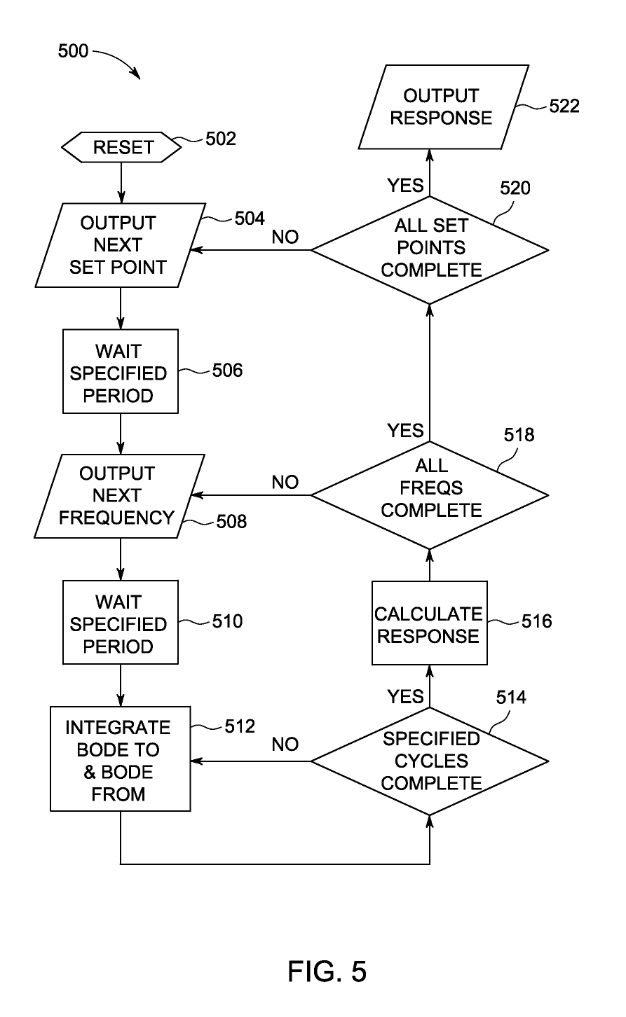

Further, the measurement function (BodeTo 316, BodeFrom 318) involves measuring the magnitude and phase shift of the stimulus sinusoidal waves, which are at various frequencies as they propagate around the control loop. The results of these measurements are then correlated to determine how close the control loop is to an unstable condition. Further, the analyzer block 40 also calculates the root-mean-square (RMS) gain for each frequency value. Unlike the correlating analysis which measures the gain and phase of only the frequency component of the stimulus, the RMS signal includes noise, harmonics, and other non-linear and uncorrelated effects. These other components can have deleterious effects on control loops and should also be considered during a control loop analysis, which will be discussed in greater detail with relation FIG. 5.

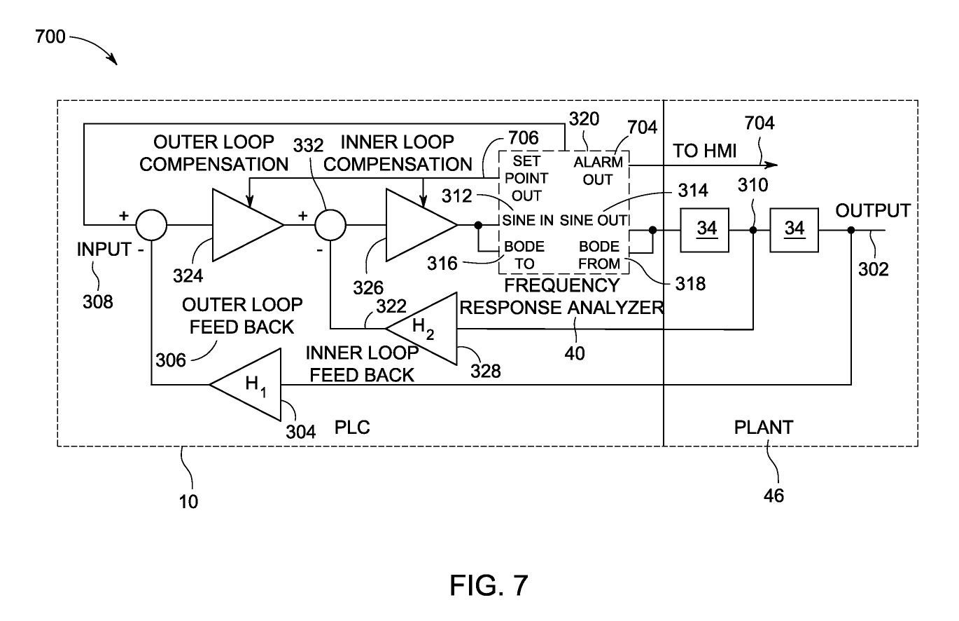

After analyzer block 40 provides a stimulus signal at a predetermined frequency to nodes 34, the signal is processed and transmitted to outputs 302 and 310, which are positioned at each node, one output 302 in communication with an outerloop 306 and the other output in communication with an inner loop 322. One node 34 is connected on output 302, while the other is connected through output 310 to transmit to the inner loop feedback 334, which is configured to transform discrete signals from the node 34 into a form usable by the PLC 10. The output signal is sent through a feedback gain (H₁) 304 as part of an outer loop feedback loop 306, whereas the output 310 is sent through feedback gain 328. The signals are then received at input 308 or 332, at which time a return signal is sent through loop compensation blocks 324 and 326 to the analyzer block 40 where error values are calculated, and adjustments to the nodes, where needed, are made using loop compensation blocks 324 and 326, which will be discussed in greater detail with relation to FIGS. 5 and 7.

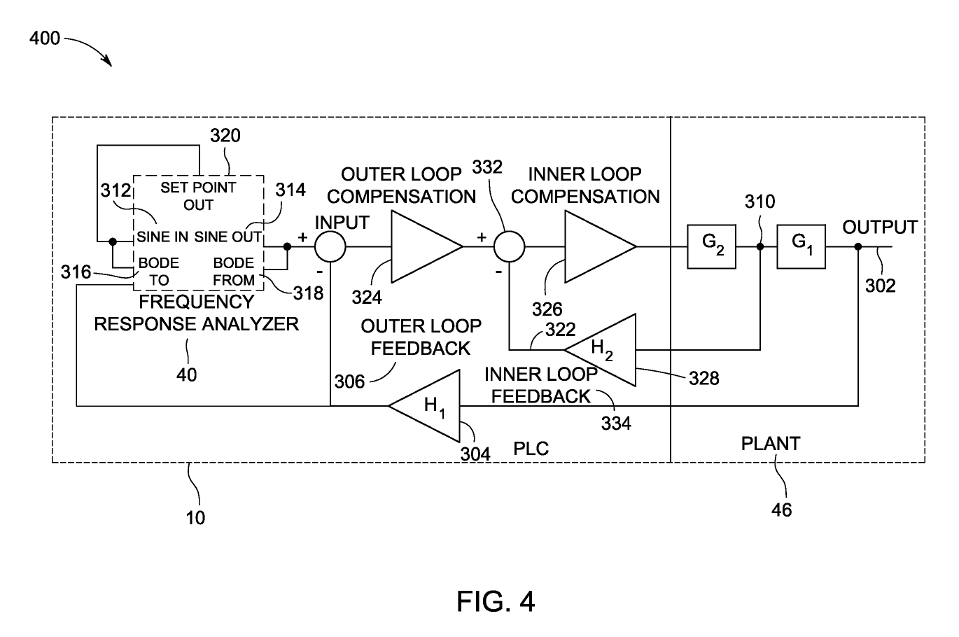

FIG. 4 illustrates a function block diagram for a closed loop measurement configuration at reference numeral 400. Like the open loop function block 300, the function block 400 is uploaded to the processor 16, and is configured to provide predetermined functionality to the control loop. However, unlike the open loop function block, the stimulus is applied to the setpoint input and the results are measured at the plant output, the analyzer is completely outside of the loop.

As shown, the function block diagram 400 has analogous elements to the function block shown in FIG. 3, in which the analyzer block 40 is inserted into the dual-loop control path, and is configured to provide both a stimulus signal, such as a sinusoidal waves at predetermined various frequency (SineIn 312 and SineOut 314), and measurement function (BodeTo 316 and BodeFrom 318), as well as the DC voltage at setpoint out 320 to bias the system nonlinear analysis. In this optional embodiment, the analyzer is completely outside of the inner loop 322 or the outer loop 306.

FIG. 5 is a schematic, operational flow chart depicting a method for acquiring and analyzing control loop data, shown at reference numeral 500, which is configured for non-linear systems. As an overview, the flow chart illustrates how the analyzer block 40 outputs multiple setpoints for measuring non-linear systems, and how at each setpoint the analyzer block 40 analyzes specified frequencies for specified amounts of time with specified settling delays being established between each step to produce an output, and where necessary, a promulgated response.

At step 502, the analyzer block 40 issues a reset command, which when executed, prepares the block 40 for the next measurement cycle. More specifically, once a reset command is issued analysis begins. During the reset function, the setpoint is set back to its first setting, the perturbation (also referred to as “stimulus”) frequency is set to its first point, and the perturbation amplitude is set to zero. The reset command can be issued by an operator, who can either set the value of the reset variable on the PLC, or in optional embodiment, the reset may be controlled using an HMI.

At step 504, the function block outputs a setpoint to a node 34. In this exemplary embodiment, the setpoint output is increased by a predetermined amount. A predetermined delay of, for example, 10 seconds, is built in at step 506 before the function block outputs a predetermined frequency e.g., 1 hz, to a node of a group of nodes that reside in the control loop step 508. Again, a predetermined delay of 1 second, for example, is built in at step 510, before the integration step 512 is performed.

At integration step 512, the analyzer block 40 acquires the point on the sine and cosine curve based on the value of a phase accumulator, in which each of three calculations may be performed in a given circumstance, e.g., when the Frequency variable changes:

PhaseStep=2.0*pi*Frequency*SamplePeriod

PhaseAccumulator=PhaseAccumulator+PhaseStep

Stimulus=sin(PhaseAccumulator)

The use of the phase accumulator eliminates discontinuity in the stimulus waveform when the frequency variable changes. Furthermore, phase accumulation is used to avoid discontinuities in the waveform when stepping from one frequency to the next. A correlation step is then performed between the sine or cosine, and the incoming waveforms by integrating the product of the sine or cosine and the input waveforms. The calculation with the sine function is the “real” component of the magnitude and phase calculation, while the calculation with the cosine is “imaginary” component of the calculation. Thereafter, the average of the incoming wave forms, and the mean-square component of the RMS calculation of the incoming waveforms are performed.

Still at integration step 512, the output of the waveforms are calculated, which is applied between the Sine-In switch 312 and Sine-Out switch 314 for the next sweep, and increments the phase accumulator accordingly. More particularly, the PLC executes the analyzer block in a first sweep, approximately, every 10 milliseconds. The analyzer block then performs a frequency sweep, in which the stimulus sweeps through a predetermined range of frequencies. In an exemplary embodiment, the analyzer block is configured to output 0.1 Hz for 10 seconds (i.e., 1 cycle), 0.5 Hz for 5 seconds, up to 25 Hz for 1 second (25 cycles). Thus, if a Frequency Sweep takes 60 seconds total, then the has taken 6000 PLC Sweeps.

The analyzer block 40 is further configured to verify that a predetermined of cycles have been complete, step 514. For example, in an exemplary embodiment, the analyzer block 40 is configured to run a predetermined number of cycles, which is a function of the amount of the time the user requires the test to take. If the analyzer block 40 concludes that the requisite number of cycles have not been completed, it is configured to return to integration step 512. If the predetermined number of cycles has been duly preformed, the analyzer block is then configured to calculate a response, step 516.

Calculating a response, step 516, is performed at each frequency step 508 and for each setpoint step 504. In operation, the analyzer block 40 is configured to calculate the magnitude of the input and output, which are the signals from the BodeTo and BodeFrom for the analyzer block 40 by taking the root of the sum of the squares of the sine integration (real) and the cosine integration (imaginary), which are then divided to calculate the gain from the output to the input. The analyzer returns three values for each frequency step; magnitude, phase, and RMS. The magnitude and phase measurements are made using a correlation step, while as the RMS is made by using the statistical Root-Mean-Square. The log is then taken to calculate the dB magnitude. Also, the final Root of the RMS is performed for the RMS calculation and is converted to dB.

During the calculate response step 516, the phase margin is defined. Phase margin in this case is defined as the minimum phase encountered while the gain is greater than 1.0. The input and output values at the end of the settling time are used as the quiescent values in the integrations above. This initial setting is compared with the actual calculated DC value at the end of the run to make sure the initial values were within a predetermined tolerance. If they are not, in an optional embodiment, an alarm or notification signal is generated.

The analyzer block 40 is further configured to verify that all predetermined frequencies have been complete. In the event the block 40 determines they have not, it will return to the output next frequency step 506, and proceed through each of the intermittent steps until the predetermined frequencies have been complete.

The analyzer block 40 is further configured to verify that all setpoints have been complete, step 520. In the event the block 40 determines they have not, it will return to the output next setpoint step 504, and proceed through each of the intermittent steps until the predetermined setpoints have been complete.

If all setpoints have been complete, the analyzer block is configured to output a response step 522. Also, optionally, the analyzer block may be configured to perform a predictive analysis based on the data received, in which the block is configured to forecast a failure of the node or if the node is near malfunction such that values will not be within the predetermined threshold.

The output can be examined by the user in a number of ways, including examining the output directly on the PLC. In this case, the PLC is configured to transform the data into User Defined Type (UDT). The UDT can store both the specifications for the Bode Loop Analysis as well as space for the analyzer to place the results. The UDT can be a table containing the test parameters (DC Steps, Frequency Steps, Settling Time, etc.) in which to place the resulting output measurements. The results can be plotted directly with PLC-based software, or can be read from the PLC via Ethernet and plotted various graphing programs. The output may also be viewed by the user on the PLC directly with a graphic output, or sent to a display module vie Ethernet or RS-232.

### Example of Acquiring and Analyzing Control Loop Feedback

The following example will serve to illustrate an example of acquiring and analyzing control loop feedback using the analyzer block, which is best understood with reference to FIG. 5.

Analyzing the response is realized using the following exemplary variables: Full range input to the control loop set at zero to ten, ten operating points from 0.5 to 9.5, settling time of ten second between operating point steps, stimulus is to be 1% of full scale, stimulus to be twenty steps between 0.1 Hz and 10 Hz with ten cycles at each step, a one second pause between each frequency step, and the PLC Scan period being ten milliseconds in length.

When the operator or user transitions RESET from TRUE to FALSE at step 502, the SetPoint output changes to 0.5 at step 504, and the SineOut port is set equal to the value that is applied to the SineIn port.

Ten seconds later (step 506) a 0.1 Hz sinewave of amplitude 0.1 is be added to the SineIn input and the sum is applied to the SineOut output (508). After ten seconds, the SineOut value is equal to the SineIn value. At 10.01 seconds, the SineOut value is “SineIn+0.1*sin(2*pi*0.1*0.01)”). At eleven seconds (step 510), the block will begin to Analyze the signals at BodeTo and BodeFrom (step 512). This process continues for ten cycles (100 seconds) (step 514). Next, after 111, the block calculates the results of the analysis at the first frequency step (516), and then begins to output the next frequency step (steps 518/508) and begin analyzing one second later (step 510). This process continues until 20 frequency steps have been generated and analyzed at which time the stimulus will stop (e.g., SineOut set equal to SineIn), and the SetPoint output will go to its next value (1.5) (steps 520/504). This process is continued at each SetPoint step until all setpoints steps are complete. At that point the block will set SineOut equal to SineIn, the results are available for downloading (step 522), and the block will go idle until RESET is set to TRUE again (step 502).

Also, in operation, the frequency response analyzer is further configured to perform phase unwrapping. To reduce numerical errors, the setpoint of the test signals is removed prior to the results being accumulated. The quiescent value is verified at the end of each frequency step and, if the quiescent value does not correspond to the quiescent value at the beginning of each frequency step, an error output is generated

Furthermore, at step 516, the frequency response analyzer is also configured to calculate the root mean square (“RMS”) gain at each frequency point, which includes the RMS information includes noise, harmonics, and other non-linear and uncorrelated effects. These other components can have deleterious effects on control loops and thus, a during a control loop analysis.

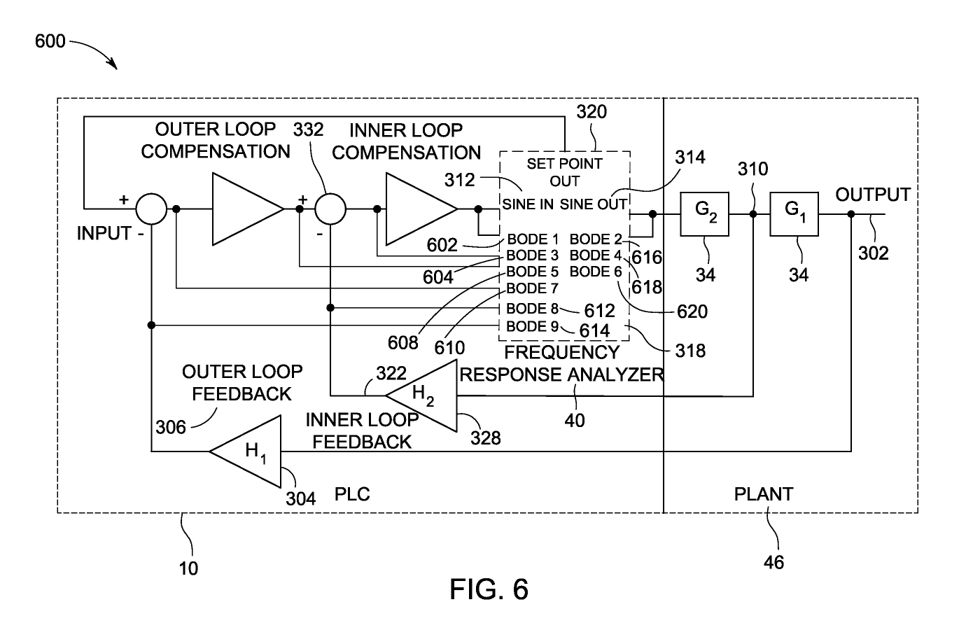

Referring now to FIGS. 6-8, optional embodiments of the present invention are shown, in which the configuration has been analyzer block 40 is altered in response to different variables. For example, in FIG. 6, as in FIGS. 3 and 4, a function block diagram is shown, in which the function block diagram 600 illustrates the functional relationship between the PLC 10 and an exemplary industrial plant 46, which has nodes 34, representing for example, control valves, gauges, pumps and the like. The analyzer block 40, which is inserted into the dual-loop control path, is configured to provide both a stimulus signal, such as a sinusoidal waves at predetermined various frequency (SineIn 312 and SineOut 314), and a measurement function, as well as the DC voltage at SetPoint Out 320 to bias the system for nonlinear analysis. However, in this exemplary embodiment, the embodiment shown in FIG. 6 that is capable of performing frequency response analysis to and from every point in a control loop. As such, the analyzer block 40 also has BodeTo port 602-6116 and BodeFrom port 616-620. In operations, if a user expects the loop phase shift (port 616 to port 602) to be 145 degrees at a predetermined frequency, but instead, it is 160 degrees, to determine where the discrepancy originates, the user can measure each block within the loop to determine which isn't behaving as expected. In this case, the engineer would analyze the inner loop components (e.g., 618-616, 612-618 and 602-612. Then, the block analyzes the outer loop starting with the closed loop inner loop (618-608) and then the remaining outer loop blocks (620-618, 614-620, 608-614). In this embodiment, all of the blocks can be characterized in one single analysis run, instead of seven traditional analysis runs. This configuration is particularly useful for determining the exact location of unexpected frequency response characteristics using only one analysis test run.

FIG. 7 is a functional block diagram similar to that shown in FIG. 3, in which the function block diagram 700 illustrate the functional relationship between the PLC 10 and an exemplary industrial plant 46, which has nodes 34. However, in this exemplary embodiment, the analyzer block 40 is configured to generate an alarm 702 to a human machine interface 704 if the control loop stability deteriorates below or above a predetermined limit. Further, the analyzer block 40 is configured to continuously monitor the control loop and adjust the loop compensation blocks 324 and 326 via line 706, to continuously maintain optimum control operation. This embodiment is particularly useful in control loops which can tolerate a small perturbation during normal operation.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

The construction and arrangement of the elements described herein are illustrative only. Although only a few embodiments have been described in detail in this disclosure, those of ordinary skill who review this disclosure will readily appreciate that many modifications are possible without materially departing from the novel teachings and advantages of the subject matter recited in the claims. Accordingly, all such modifications are intended to be included within the scope of the methods and systems described herein.

The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

What is claimed is:

1. A programmable logic controller comprising:
an interface having at least one input/output terminal configured for connection to a plurality of nodes within a control loop;
a proportional-integral-derivative controller coupled to the input module;
an analyzer block coupled to the proportional-integral-derivative controller and the output, the analyzer block configured to acquire data for the control loop and analyze the data directly on the programmable logic controller.

2. The programmable logic controller of claim 1, further comprising a central processing unit in communication with a processor, wherein the processor is configured to execute instructions received from each of the proportional-integral-derivative controller and the analyzer block.

3. The programmable logic controller of claim 1, wherein the analyzer block is configured to transmit a stimulus signal having varying frequencies over the control loop and to the nodes, and is further configured to receive a response to the stimulus which is measured by the analyzer block.

4. The programmable logic controller of claim 1, further comprising an outer loop feedback having a feedback gain and a loop compensation connected in circuit, wherein control loop data is filtered through each of the feedback gain and loop compensation to the analyzer block.

5. The programmable logic controller of claim 1, further comprising an inner loop feedback in communication with the node and configured to transform a signal received from the node into a form usable by the programmable logic controller.

6. A system for monitoring a control loop, the control loop having at least one node; the system comprising:
a programmable logic controller having at least one input/output terminal configured for connection to the at least node within the control loop and comprising;
a proportional-integral-derivative controller coupled to the input module; and
an analyzer block coupled to the proportional-integral-derivative controller and the output;
wherein the proportional-integral-derivative controller is configured to receive data from the node and execute a function in response to the data received; and
wherein the analyzer block is connected directly into the control loop and is configured to acquire data for the at least one node on the control loop and analyze the data directly on the programmable logic controller.

7. The system of claim 6, wherein the node comprises a valve and is in communication with a sensor, the sensor being in communication with the input module of the programmable logic controller.

8. The system of claim 6, wherein the analyzer block is configured to transmit a stimulus signal having varying frequencies over the control loop and to the nodes, and is further configured to receive a response to the stimulus which is measured by the analyzer block.

9. The system of claim 6, wherein the programmable logic controller further comprises an outer loop feedback having a feedback gain and a loop compensation connected in circuit, wherein control loop data is filtered through each of the feedback gain and loop compensation to the analyzer block.

10. A computer processor for use with a programmable logic controller having an input/output interface in communication with a node in a control loop, the processor being configured to execute programmable instructions, which when executed by the processor cause the processor to:
transmit a stimulus signal having varying frequencies over the control loop and to the nodes;
acquire data from the node on the control loop based on the received stimulus signals; and
algorithmically analyze the control loop data directly on the programmable logic controller.

11. The processor of claim 10, wherein the processor is further configured to:
continuously monitor the control loop; and
categorically adjust parameters of the control loop based upon a node feedback to optimize a function of the control loop.

12. The processor of claim 10, wherein the processor is further configured to notify an operator if the control loop data reaches a predetermined threshold value.

13. The processor of claim 10, wherein the control loop data comprises a frequency response from each node of the plurality of nodes as a response to the stimulus, and wherein the processor is further configured to execute a frequency response analysis algorithm at the programmable logic controller for each of the frequency responses.

14. The processor of claim 13, wherein the control loop comprises an open loop or a closed loop, and the processor is further configured to acquire and analyze data from the open loop without manually opening the loop.

15. The processor of claim 10, wherein the processor is further configured to:
add a sine wave the stimulus;
analyze each of the frequency responses at predetermined intervals to verify a response value; and
confirm that each of the frequency response values for each node has been analyzed before an output is generated;
wherein if the frequency response values are not with a predetermined range, an error output is generated.

16. The processor of claim 10, wherein the processor is further configured to:
calculate a root mean square gain at for each of the plurality of frequency response values for each node to offset deleterious effects.

17. The processor of claim 10, wherein the processor is further configured to conduct a predictive analysis on the control loop.

18. A method for acquiring and analyzing control loop data, the control loop having a plurality of nodes, the method executable by a processor, comprising:
outputting a stimulus at a predetermined frequency to at least one node;
receiving data from the nodes; and
algorithmically analyze the node data directly on the programmable logic controller.

19. The method of claim 18, further comprising:
continuously monitoring the control loop; and
categorically adjusting parameters of the control loop based upon the node data to optimize a function of the control loop.

20. The method of claim 18, further comprising notifying an operator if the control loop data reaches a predetermined threshold value.

21. The method of claim 18, wherein the receiving data from the nodes comprises: receiving a frequency response from each node of the plurality of nodes; and
executing a frequency response analysis algorithm at the programmable logic controller for each of the frequency responses.

22. The method of claim 18, wherein the control loop comprises an open loop or a closed loop, and acquiring and analyzing data from the open loop occurs without manually opening the loop.

23. The method of claim 18, further comprising:
analyzing each of the frequency responses at predetermined intervals to verify a response value; and
confirming that each of the frequency response values for each node has been analyzed before an output is generated;
generating an output if the frequency response values are not with a predetermined range.

24. The method of claim 18, further comprising:
calculating a root mean square gain at for each of the plurality of frequency values for each node to offset deleterious effects.

25. The method of claim 18, further comprising executing instructions to conduct a predictive analysis on the control loop.

26. The method of claim 18, further comprising logging the frequency data at predetermined intervals and communicate the output to a user.

27. The method of claim 18, wherein generating an output further comprises transforming the output into User Defined Type viewable by a user.
